(19) United States
(12) Patent Application Publication
(10) Pub. No.: US 2018/0189459 A1
(43) Pub. Date: Jul. 5, 2018

(54) PATIENT LAB TEST COMPLIANCE SYSTEM AND METHOD

(71) Applicant: Med Mio, LLC, Austin, TX (US)

(72) Inventors: Misha Diden, Austin, TX (US); Tiffany Reichle, Spicewood, TX (US); Thomas Blevins, Austin, TX (US); Rob Cowart, Austin, TX (US)

(21) Appl. No.: 15/474,579

(22) Filed: Mar. 30, 2017

Related U.S. Application Data
(60) Provisional application No. 62/441,654, filed on Jan. 3, 2017.

(51) Int. Cl. G06F 19/00; G06Q 10/10

(52) U.S. Cl. CPC G06F 19/366; G06Q 10/109

(57) ABSTRACT

Patient lab test compliance systems and methods of tracking a lab test order. In one embodiment, the method includes receiving the lab test order via a transceiver included in the portable electronic device. The lab test order includes a patient identifier, an action due date, and a lab test identifier. The method also includes setting and starting, via an electronic processor included in the portable electronic device, a first timer based at least in part on the action due date. The method further includes generating a reminder alarm signal after the first timer expires. The method also includes displaying the lab test identifier on a touch-screen display included in the portable electronic device.

### RELATED APPLICATIONS

This application claims priority to U.S. Provisional Application No. 62/441,654, entitled “PATIENT LAB TEST COMPLIANCE SYSTEM AND METHOD,” filed Jan. 3, 2017, the entire contents of which is incorporated herein by reference.

### BACKGROUND

Medical practices, such as endocrine medical practices, require a lot of a lab testing. These medical practices often see patients several times each year. Prior to each office visit, patients are required to have lab tests administered so that the results of these lab tests can be analyzed and discussed during the office visit. Patients typically receive paper copies of lab test orders as a reminder of which lab tests that they need to have administered prior to the next office visit. Patients, however, often misplace these paper lab test orders and subsequently arrive at the next office visit without having completed the required lab tests. As a result, the office visit is unproductive and typically needs to be rescheduled so that the patient can have the necessary lab tests administered.

### SUMMARY

There is a need for a reliable and patient-friendly system of reminding patients to have their lab tests administered before a scheduled office visit. With the present disclosure, patients receive such reminders and other helpful information via a portable electronic device (for example, a mobile phone or a smart phone) without needing to complete a lot of setup work.

Thus, the disclosure provides a method of tracking a lab test order on a portable electronic device. In one embodiment, the method includes receiving the lab test order via a transceiver included in the portable electronic device. The lab test order includes a patient identifier, an action due date, and a lab test identifier. The method also includes setting and starting, via an electronic processor included in the portable electronic device, a first timer based at least in part on the action due date. The method further includes generating a reminder alarm signal after the first timer expires. The method also includes displaying the lab test identifier on a touch-screen display included in the portable electronic device.

The disclosure also provides a method of tracking a lab test order on a server. In one embodiment, the method includes receiving a lab test input from a doctor terminal, via a server transceiver included in the server. The lab test input includes a patient identifier, an action due date, and a lab test identifier. The method also includes transmitting the lab test input to a lab database, via the server transceiver. The method further includes determining, via a server electronic processor included in the server, a patient reminder date based at least in part on the action due date. The method also includes transmitting the lab test order to a portable electronic device, via the server transceiver. The lab test order includes the action due date, the patient reminder date, and the lab test identifier.

The disclosure also provides a non-transitory computer-readable storage medium. The non-transitory computer-readable storage medium includes program instructions. In one embodiment, when executed by an electronic processor of a portable electronic device, the program instructions cause the electronic processor to receive a lab test order. The lab test order includes a patient identifier, an action due date, and a lab test identifier. The program instructions also cause the electronic processor to set and start a first timer based at least in part on the action due date. The program instructions further cause the electronic processor to generate a reminder alarm signal after the first timer expires. The program instructions also cause the electronic processor to display the lab test identifier on a touch-screen display of the portable electronic device.

Other aspects of the disclosure will become apparent by consideration of the detailed description and accompanying drawings.

### BRIEF DESCRIPTION OF THE DRAWINGS

FIG. 1 is a diagram of a patient lab test compliance system, in accordance with some embodiments.

FIG. 2 is a diagram of a portable electronic device included in the patient lab test compliance system of FIG. 1, in accordance with some embodiments.

FIG. 3 is a diagram of a server included in the patient lab test compliance system of FIG. 1, in accordance with some embodiments.

FIG. 4 is a flowchart of a method of tracking a lab test order on the portable electronic device of FIG. 2, in accordance with some embodiments.

FIGS. 5A through 5E are exemplary screenshots of a touch-screen display included in the portable electronic device of FIG. 2, in accordance with some embodiments.

FIG. 6 is a flowchart of a method of generating and tracking a lab test order on the server of FIG. 3, in accordance with some embodiments.

### DETAILED DESCRIPTION

For ease of description, each of the exemplary systems presented herein is illustrated with a single exemplar of each of its component parts. Some examples may not describe or illustrate all components of the systems. Other exemplary embodiments may include more or fewer of each of the illustrated components, may combine some components, or may include additional or alternative components.

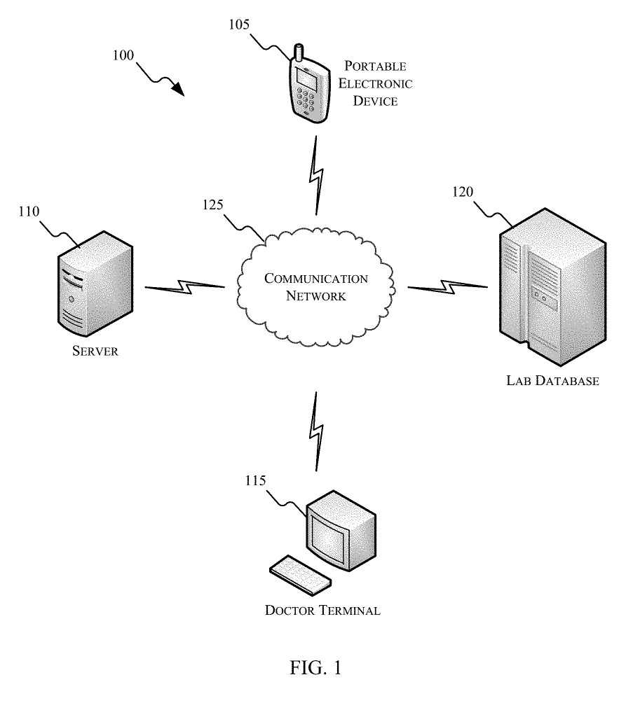

FIG. 1 is a diagram of one exemplary embodiment of a patient lab test compliance system 100 for lab test orders. The patient lab test compliance system 100 includes a portable electronic device 105 (for example, a mobile phone, a smart phone, a tablet, and the like), a server 110, a doctor terminal 115, a lab database 120, and a communication network 125. As described below in more detail, the portable electronic device 105 generates reminders to encourage a patient to have lab tests administered. The doctor terminal 115 provides an entry point for medical personnel (for example, doctors and nurses) to enter lab test input for lab test orders. The server 110 receives the lab test input from the doctor terminal 115 and transmits it the portable electronic device 105 and the lab database 120. The lab database 120 provides the lab test input to lab testing facilities.

The communication network 125 may be a wired network, a wireless network, or both. All or parts of the communication network 125 may be implemented using various networks, for example, a cellular network, the Internet, a Bluetooth™ network, a wireless local area network (for example, Wi-Fi), a wireless accessory Personal Area Networks (PAN), cable, an Ethernet network, satellite, a machine-to-machine (M2M) autonomous network, and a public switched telephone network. The portable electronic device 105, the server 110, the doctor terminal 115, and the lab database 120 communicate with each other over the communication network 125 using suitable wireless or wired communication protocols. In some embodiments, communications with other external devices (not shown) occur over the communication network 125.

The patient lab test compliance system 100 illustrated in FIG. 1 is provided as one example of such a system. The methods described herein may be used with compliance systems with fewer, additional, or different components in different configurations than the patient lab test compliance system 100 illustrated in FIG. 1. For example, in some embodiments, the patient lab test compliance system 100 includes fewer or additional servers and may include fewer or additional lab databases.

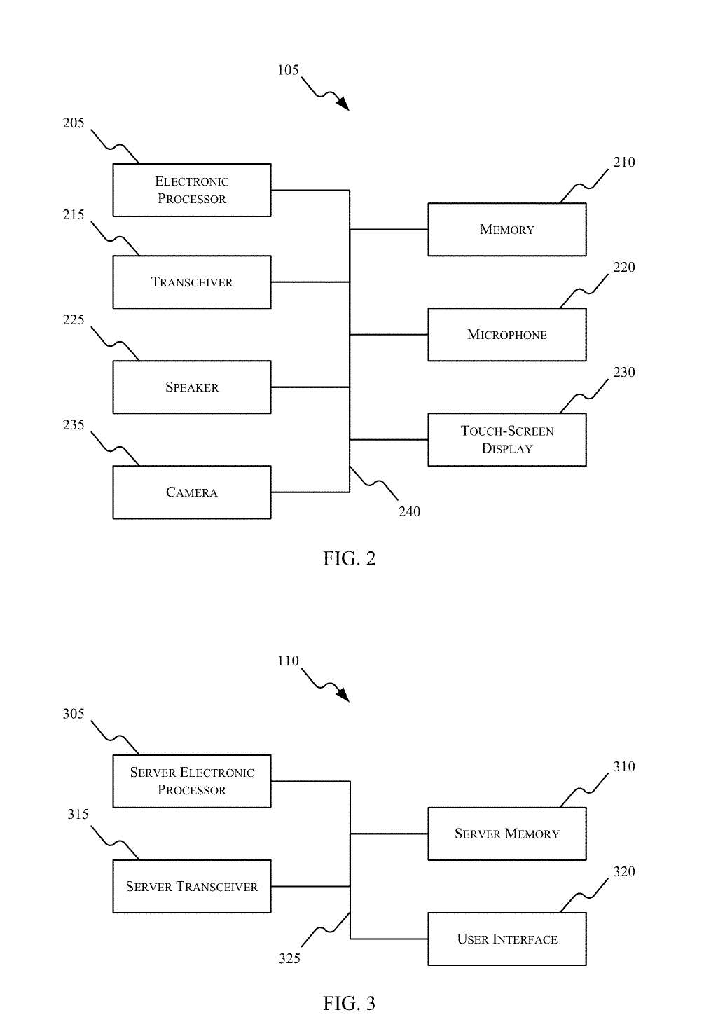

FIG. 2 is a diagram of one exemplary embodiment of the portable electronic device 105. In the embodiment illustrated, the portable electronic device 105 includes an electronic processor 205 (for example, a microprocessor, or other electronic controller), a memory 210, a transceiver 215, a microphone 220, a speaker 225, a touch-screen display 230, and a camera 235. The electronic processor 205, the memory 210, as well as the other various modules are coupled by a bus 240, or are coupled directly, by one or more additional control or data buses, or a combination thereof. In alternate embodiments, the portable electronic device 105 may include fewer or additional components in configurations different from the configuration illustrated in FIG. 2.

The memory 210 may include read only memory (ROM), random access memory (RAM), other non-transitory computer-readable media, or any combination thereof. The electronic processor 205 is configured to retrieve program instructions and data from the memory 210 and execute, among other things, instructions to perform the methods described herein.

The transceiver 215 transmits signals to the communication network 125 and receives signals from the communication network 125. In some embodiments, signals include, for example, lab test orders, reminder alarm signals, action complete signals, overdue alarm signals, data, data packets, or any combination thereof. In some embodiments, the transceiver 215 includes a separate transmitter and receiver.

The microphone 220 detects sound and outputs analogous electric signals representing the sound to the electronic processor 205. The speaker 225 receives electric signals from the electronic processor 205 and outputs sound.

The touch-screen display 230 is a touch-sensitive interface that displays visual output generated by software applications executed by the electronic processor 205. Visual output includes, for example, graphical indicators, lights, colors, text, images, webpages, graphical user interfaces (GUIs), combinations of the foregoing, and the like. The touch-screen display 230 includes a suitable display mechanism for displaying the visual output (for example, a light-emitting diode (LED) screen, a liquid crystal display (LCD) screen, and the like). The touch-screen display 230 also receives user input using detected physical contact (for example, detected capacitance or resistance). Based on the user input, the touch-screen display 230 outputs signals to the electronic processor 205 which indicate positions on the touch-screen display 230 currently being selected by physical contact.

The camera 235 includes one or more optical sensors that capture optical signals. For example, the camera 235 may include charged-coupled devices (CCDs) that capture an image, a series of images, video, and the like.

FIG. 3 is a diagram of one exemplary embodiment of the server 110. In the example illustrated, the server 110 includes a server electronic processor 305, server memory 310, a server transceiver 315, and a user interface 320. The server electronic processor 305, the server memory 310, as well as the other various modules are coupled by a bus 325, or are coupled directly, by one or more additional control or data buses, or a combination thereof. In other embodiments, the server 110 may include fewer or additional components in configurations different from that illustrated in FIG. 3.

The server memory 310 stores program instructions and data. The server memory 310 may include combinations of different types of memory, including the various types of memory described above with respect to the memory 210 included in the portable electronic device 105. The server electronic processor 305 retrieves program instructions from the server memory 310 and executes the instructions to perform a set of functions including all or part of the methods described herein. The server transceiver 315 transmits signals to and receives signals from the portable electronic device 105 and the other components included in the patient lab test compliance system 100, such as through the communication network 125 or directly. In some embodiments, signals include, for example, lab test orders, lab test input, reminder alarm signals, action complete signals, overdue alarm signals, data, data packets, or any combination thereof. The user interface 320 includes any combination of digital and analog input devices required to achieve a desired level of control for the system. For example, the user interface 320 can include a computer having a display and input devices, a display, a keyboard, a mouse, speakers, and the like.

In some embodiments, the doctor terminal 115 and the lab database 120 may include components or combinations of different components, including all or some of the various components described above with respect to the server 110.

As discussed above, there is a need for a reliable and patient-friendly system of tracking lab test orders and reminding patients to have their lab tests administered timely. Many patients own a portable electronic device 105, as described herein. The patient lab test compliance system 100, described herein, uses the portable electronic device 105 of the patient to track lab test orders and provides patients with reminders and other useful information to encourage patients to have their lab tests administered before a scheduled office visit.

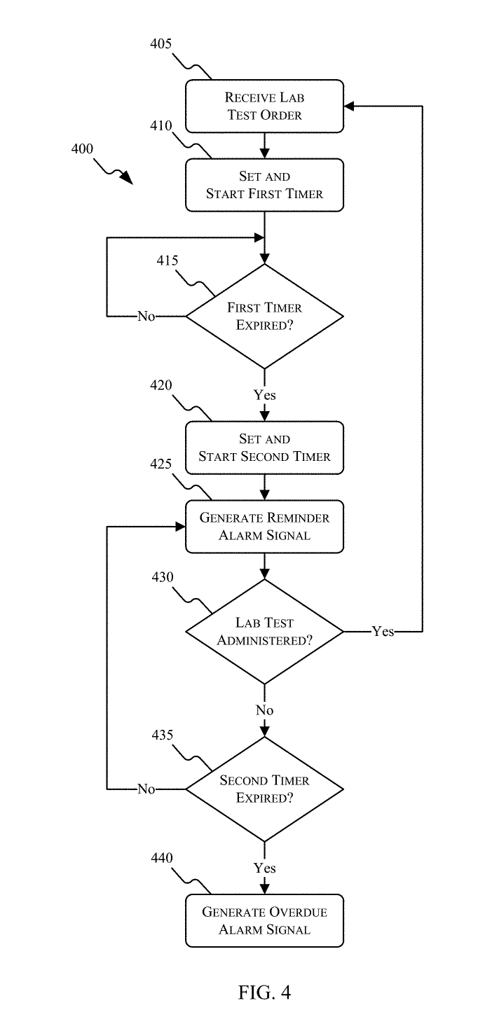

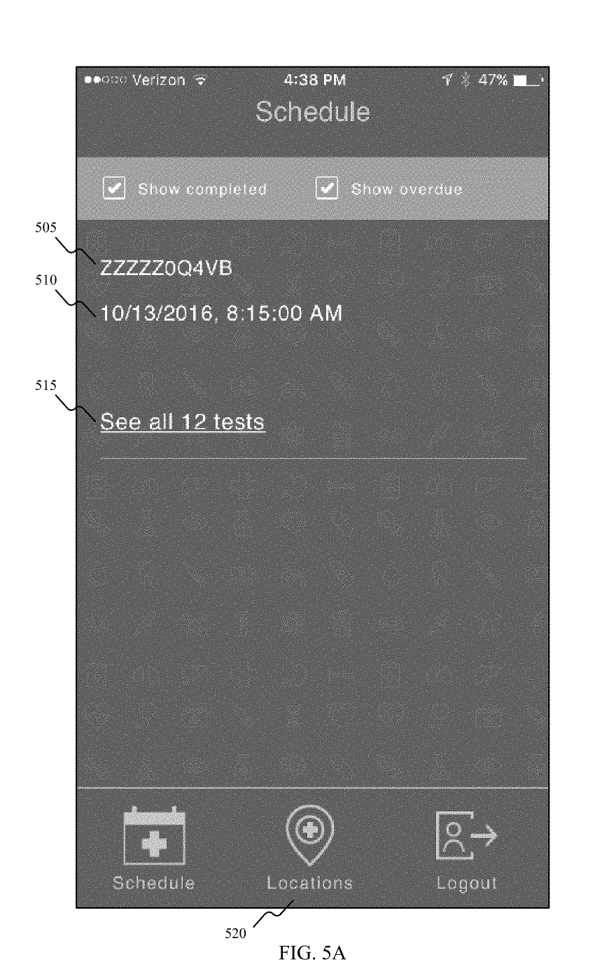

FIG. 4 illustrates an exemplary method 400 of tracking a lab test order for a patient on the portable electronic device 105. In the example illustrated, the method 400 includes the electronic processor 205 receiving a lab test order from the server 110 (at block 405). The lab test order includes, for example, one or more lab test identifiers, a patient identifier, an action due date, a patient reminder date, a unique lab test order identifier, or any combination thereof. In some embodiments, the server 110 receives the lab test order (or information used to create the lab test order) from the doctor terminal 115, as explained in more detail below.

Each lab test identifier indicates a specific lab test (or set of lab tests) that have been ordered for the patient. Each lab test identifier includes, for example, lab test ordering codes used by medical practices and medical insurance companies (for example, a current procedural technology code (CPT code)), lab test ordering codes used by lab testing facilities (for example, a clinical pathology lab code (CPL code)), other lab test ordering codes (for example, a logical observation identifier names and codes (LOINC)), or any combination thereof. Different lab testing facilities may use different lab testing codes. Thus, in some embodiments, each lab test identifier includes different lab test ordering codes for different lab testing facilities.

In some embodiments, the lab test identifier includes patient instructions for lab tests. For example, the lab test identifier may indicate that the patient needs to fast for a set period of time prior to having a lab test administered.

The patient identifier identifies the patient to which the lab tests have been ordered. The patient identifier may include, for example, patient name, patient account number, patient date of birth, patient gender, patient phone number, patient mailing address, patient email address, or any combination thereof.

The action due date indicates the date by which the patent should have the lab tests administered. In some embodiments, the action due date is the date of the patient's next appointment at the medical office. In other embodiments, the action due date is a date prior to the patient's next appointment. For example, the action due date may be a date that is one day prior to the date of the patient's next appointment.

The patient reminder date indicates when reminders should be generated for the patient. In some embodiments, the patient reminder date is included in the lab test order. In other embodiments, the electronic processor 205 determines the patient reminder date based at least in part on the action due date. For example, the electronic processor 205 sets the patient reminder date to a date that is two weeks prior to the action due date.

The unique lab test order identifier differentiates one lab test order from another lab test order. While multiple lab test orders may include the same patient identifier or lab test identifiers, the unique lab test order identifier is different for each lab test order. The unique lab test order includes, for example, a requisition number.

Returning to FIG. 4, at block 410, the electronic processor 205 sets and starts a first timer. The first timer represents a time period after which reminders will be provided to encourage the patient to have necessary lab tests administered prior to the action due date. The electronic processor 205 sets the first timer based at least in part on the patient reminder date. For example, the electronic processor 205 sets the first timer to a time period that expires on the patient reminder date.

In some embodiments, the electronic processor 205 sets the first timer to a time period that expires at a set time of day on the patient reminder date. For example, the electronic processor 205 sets the first timer to a time period that expires at 8:00 AM on the patient reminder date. In some embodiments, the set time of day is predetermined. In other embodiments, the electronic processor 205 determines the set time of day based at least in part on the lab test order identifiers. As explained above, the lab test order identifiers may indicate that a patient needs to fast for a specific time period prior to having a lab test administered. Thus, in some embodiments, the electronic processor 205 sets the first timer to a time period that expires on the evening prior to the patient reminder date when fasting is required (for example, at 8:00 PM).

At block 415, the electronic processor 205 determines when the first timer has expired. When the first timer expires, the electronic processor 205 sets and starts a second timer (at block 420). The second timer represents a time period after which it may be too late for the patient to have lab tests administered (for example, prior to a scheduled appointment date). The electronic processor 205 sets the second timer based at least in part on the action due date. In some embodiments, the electronic processor 205 sets the second timer to a time period that expires on the action due date.

At block 425, the electronic processor 205 generates a reminder alarm signal after the first timer expires. The reminder alarm signal reminds the patient to have their lab tests administered timely. In the some embodiments, the reminder alarm signal triggers a visual signal, an auditory signal, or both. For example, the touch-screen display 230 displays a message when the reminder alarm signal is generated. As a further example, a portion of text or a date displayed by the touch-screen display 230 changes color (for example, from white to yellow) when the reminder alarm signal is generated. In some embodiments, the speaker 225 generates an audible sound (for example, a chime, a tone, an auditory message, and the like) when the reminder alarm signal is generated. The purpose of the output is to indicate the need to receive another input. As an example, the reminder alarm signal is intended to indicate that it is time for the patient to have lab tests administered in preparation for an upcoming office appointment.

At block 430, the electronic processor 205 determines whether the lab tests have been administered. In some embodiments, the electronic processor 205 makes this determination when an action complete signal is received. In some embodiments, the action complete signal is generated based on user input received by the touch-screen display 230. For example, the electronic processor 205 detects, based on signals received from the touch-screen display 230, when a user's finger touches a button displayed on the touch-screen display 230.

In some embodiments, the electronic processor 205 receives the action complete signal from the server 110. For example, after a patient has lab tests administered at lab testing facility, the lab testing facility transmits a signal to the server 110 indicating the lab tests that were administered and the date that the lab tests were administered.

Upon determining that the lab tests have been administered, the electronic processor 205 may perform one or more actions. In the embodiment illustrated in FIG. 4, the electronic processor 205 receives another lab test order (returns to block 405). In some embodiments, the electronic processor 205 stops the second timer. In some embodiments, the electronic processor 205 sends the action complete signal to the server 110. In some embodiments, the electronic processor 205 displays a visual indication on the touch-screen display 230 that the lab tests have been administered.

Alternatively, when the lab tests have not been administered, the electronic processor 205 determines whether the second timer has expired (at block 435). If the second timer has not yet expired, the electronic processor 205 generates another reminder alarm signal (returns to block 425). In this manner, the electronic processor 205 periodically generates reminder alarm signals until receiving the action complete signal or until the second timer expires. In some embodiments, the electronic processor 205 generates a reminder alarm signal once a day.

When the second timer expires prior to receiving the action complete signal (i.e., the lab tests have not been administered by the action due date), the electronic processor 205 generates an overdue alarm signal (at block 440). The overdue alarm signal indicates that it may be too late for the patient to have the lab tests administered (for example, prior to a scheduled appointment date). In some embodiments, the overdue alarm signal triggers a visual signal, an auditory signal, or both. For example, the touch-screen display 230 displays a message when the overdue alarm signal is generated. As a further example, a portion of text or a date displayed by the touch-screen display 230 changes color (for example, from white to red) when the overdue alarm signal is generated. In some embodiments, the speaker 225 generates an audible sound (for example, a chime, a tone, an auditory message, and the like) when the overdue alarm signal is generated. In some embodiments, the electronic processor 205 transmits the overdue alarm signal to the server 110.

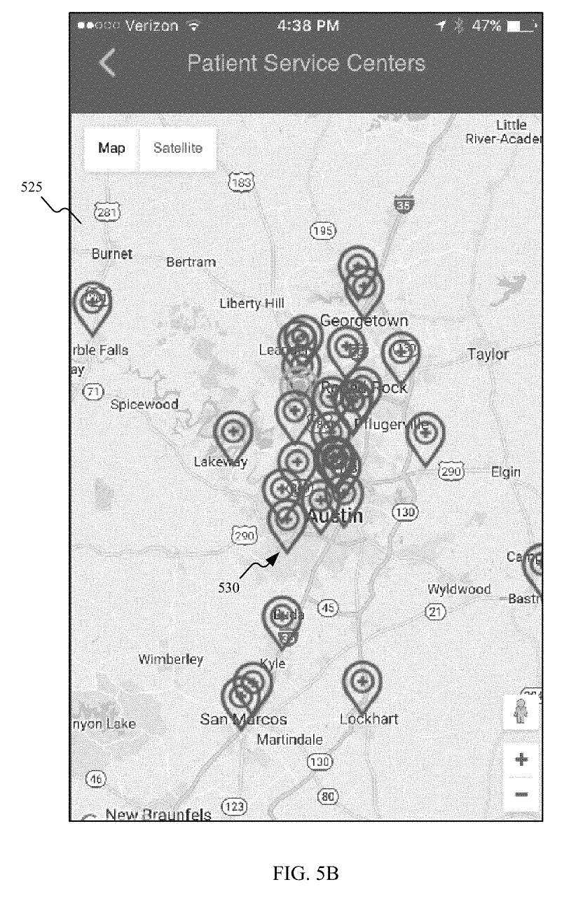

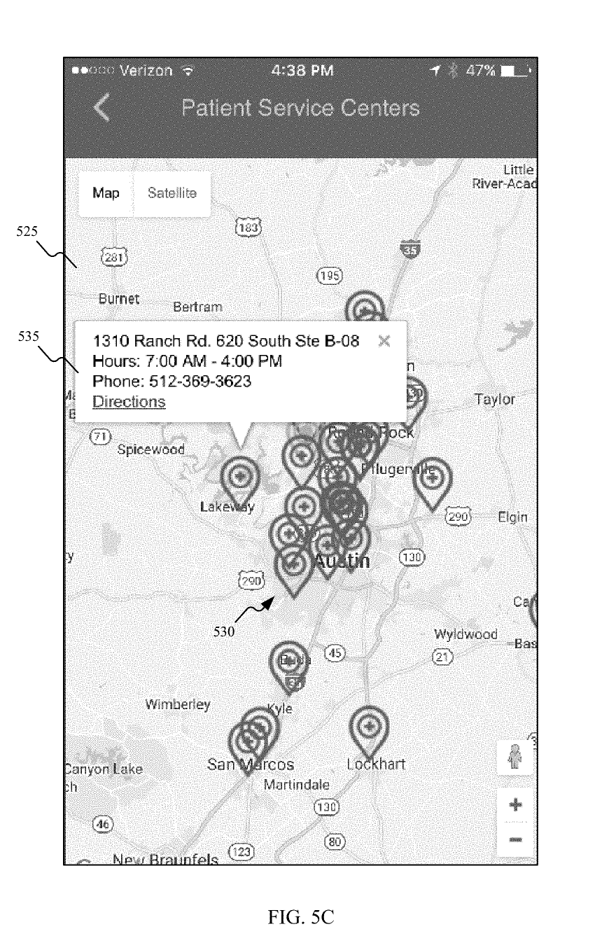

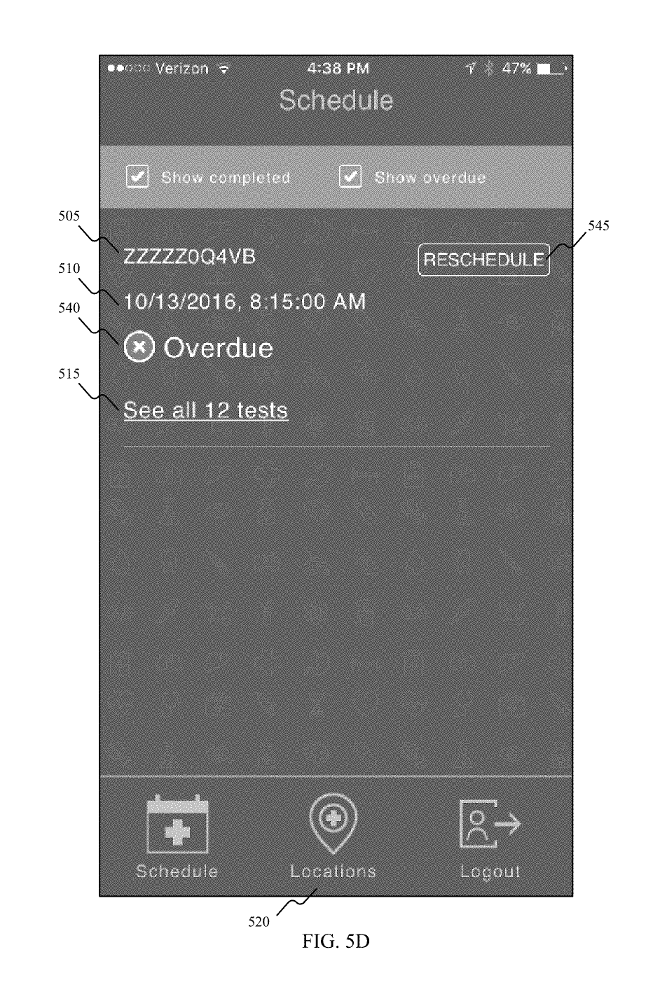

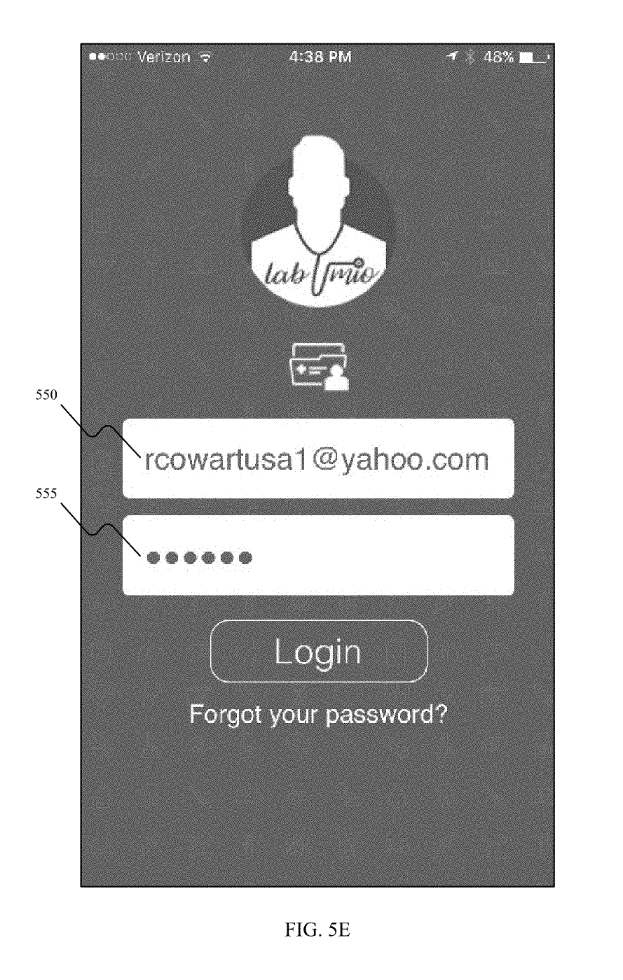

FIGS. 5A through 5E illustrate exemplary screenshots of the touch-screen display 230. The screenshot of the touch-screen display 230 in FIG. 5A includes, among other things, a unique lab test order identifier 505, an action due date 510, lab test identifiers 515, a locations button 520.

FIG. 5B illustrates the touch-screen display 230 when the locations button 520 is selected (for example, by the user). The screenshot of the touch-screen display 230 in FIG. 5B includes a map 525 and a plurality of location icons 530. The plurality of location icons 530 indicate the locations of lab testing facilities where the patient can have lab tests administered. In some embodiments, the portable electronic device 105 only displays lab testing facilities that accept the patient's medical insurance coverage. In some embodiments, in response to receiving signals from the touch-screen display 230 indicating that one of the plurality of location icons 530 has been selected, the touch-screen display 230 displays biographical information 535 for the selected lab testing facility, as illustrated in FIG. 5C. The biographical information 535 displayed in FIG. 5C includes an address, hours of operation, and a telephone number for the selecting lab testing facility.

FIG. 5D illustrates when the overdue alarm signal has been generated. The screenshot of the touch-screen display 230 in FIG. 5D includes, among other things, a visual indication 540 that the lab test order is overdue and a reschedule button 545. In response to detecting, based on signals received from the touch-screen display 230, when the user's finger touches the reschedule button 545, the electronic processor 205 dials a telephone number of the patient's medical practice office so that the patient can reschedule an upcoming office appointment.

FIG. 5E illustrates a login screen displayed on the touch-screen display 230. The user enters a patient identifier 550 (for example, an email address) and a password 555 into the touch-screen display 230. The portable electronic device 105 transmits the patient identifier 550 and the password 555 to the server 110 for authentication. Upon authenticating the patient identifier 550 and the password 555, the server 110 transmits lab test orders to the portable electronic device 105, as described herein.

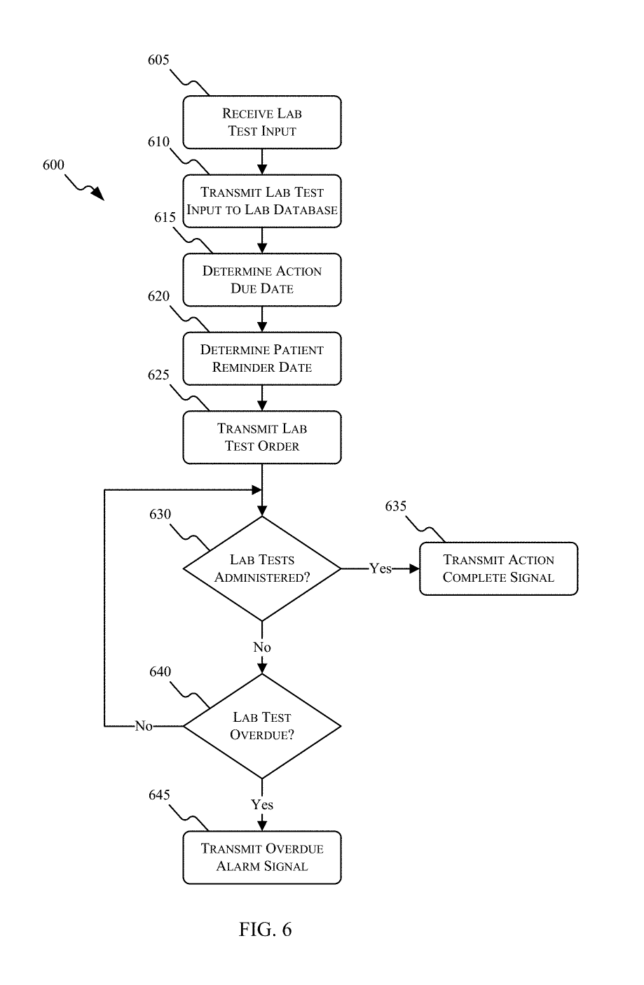

As described above, the portable electronic device 105 receives lab test orders from the server 110. FIG. 6 illustrates an exemplary method 600 of generating and tracking lab test orders with the server 110. In the example illustrated, the method 600 includes the server electronic processor 305 receiving a lab test input (at block 605). In some embodiments, the server 110 receives the lab test input from the doctor terminal 115. For example, a medical professional enters the lab test input via a keyboard that is included in the doctor terminal 115.

In some embodiments, the lab test input includes all (or any combination) of the elements described above in relation to lab test orders (for example, lab test identifiers, patient identifier, patient reminder date, action due date, and unique lab test order identifier). Alternatively, or in addition, the lab test input includes a client identifier.

The client identifier identifies the medical practice providing the order for the lab tests. As described above, in some embodiments, the server 110 receives the lab test input from the doctor terminal 115. The client identifier may include biographical data about the medical practice. For example, the name of the medical practice, an account number for the medical practice, a location of an office of the medical practice, and contact information (such as, an office phone number, an office fax number, and an email address). In addition, in some embodiments, the client identifier includes identification information for the doctor that ordered the lab tests (for example, a doctor license number). In addition, in some embodiments, the client identifier includes identification information for the specific medical personnel entering the lab test data into the doctor terminal 115. For example, the client identifier includes an identification number of the burse that enters the lab test input into the doctor terminal 115.

Returning to FIG. 6, at block 610, the server 110 transmits all (or a portion) of the lab test input to the lab database 120. For example, the server 110 transmits the lab test input to Atlas medical database. In some embodiments, the server 110 transmits the lab test input to several lab test databases. As described above, the lab database 120 provides the lab test input to lab testing facilities. Many lab testing facilities are walk-in. In other words, patients are not required to schedule an appointment prior to having lab tests administered. Transmitting the lab test input to the lab database 120 enables lab testing facilities to have the necessary lab test information when patients arrive to have lab tests administered.

At block 615, the server electronic processor 305 determines an action due date. As described above, the action due date indicates the date by which the patent should have the lab tests administered. In some embodiments, the action due date is included in the lab test input.

At block 620, the server electronic processor 305 determines a patient reminder date. As described above, the patient reminder date indicates when reminders should be generated for the patient. In some embodiments, the patient reminder date is included in the lab test input. In other embodiments, the server electronic processor 305 determines the patient reminder date based at least in part on the action due date. For example, the server electronic processor 305 sets the patient reminder to a date that is two weeks prior to the action due date.

At block 625, the server electronic processor 305 transmits a lab test order to the portable electronic device 105. As described above, the lab test order includes, for example, one or more lab test identifiers, a patient identifier, an action due date, a patient reminder date, a unique lab test order identifier, or any combination thereof. In some embodiments, the server electronic processor 305 transmits the lab test order data to portable electronic device 105 in response to receiving a login request from the portable electronic device 105.

At block 630, the server electronic processor 305 determines whether the lab tests have been administered. In some embodiments, the server electronic processor 305 makes this determination when an action complete signal is received. The server electronic processor 305 receives the action complete signal from the portable electronic device 105, the doctor terminal 115, the lab database 120, or any combination thereof.

In some embodiments, as illustrated in FIG. 6, the server electronic processor 305 transmits (or retransmits) the action complete signal (at block 635) upon determining that the lab tests have been administered. For example, upon receiving the action complete signal from the portable electronic device 105, the server 110 transmits the action complete signal to the doctor terminal 115. As a further example, upon receiving the action complete signal from the lab database 120, the server 110 transmits the action complete signal to the portable electronic device 105 and to the doctor terminal 115.

Alternatively, when the lab tests have not been administered, the server electronic processor 305 determines whether the lab tests are overdue (at block 640). In some embodiments, the server electronic processor 305 determines that the lab tests are overdue upon receiving an overdue alarm signal from the portable electronic device 105.

The server electronic processor 305 continues to determine whether the lab tests have been administered (returns to block 630) until determining that the lab tests are overdue. Upon determining that the lab tests are overdue, the server electronic processor 305 transmits (or retransmits) an overdue alarm signal (at block 645). For example, upon receiving the overdue alarm signal from the portable electronic device 105, the server 110 transmits the action complete signal to the doctor terminal 115.

The medical insurance company of the patient may only cover specific lab tests at specific intervals. For example, a medical insurance company may only reimburse for one A1C test every three months. Thus, in some embodiments, the server electronic processor 305 determines the patient reminder date based on medical insurance information associated with the patient and the date that the same lab test was previously administered. Medical insurance information includes, for example, the frequency of coverage for specific lab tests. For example, the server electronic processor 305 sets the patient reminder date such that the patient will be eligible to receive reimbursement from their medical insurance company if the patient has the lab tests administered on or after the patient reminder date.

In some embodiments, the server electronic processor 305 determines the medical insurance information based at least in part on the patient identifier. For example, the server electronic processor 305 determines the patient's medical insurance company and the patient's policy number based on the patient identifier. Using this information, the server electronic processor 305 determines the medical insurance information.

As described above, the server electronic processor 305 receives the action complete signal after the lab tests have been administered. In some embodiments, the action complete signal indicates the date at which the lab tests were administered. By storing this date and the associated lab test identifiers (for example, in the server memory 310), the server electronic processor 305 can later access this date to determine when a patient previously had a specific lab test administered.

In some embodiments, the portable electronic device 105 also accesses the dates and associated lab test identifiers of previously administered lab tests. In some embodiments, this information is stored in the memory 210 of the portable electronic device 105. In other embodiments, the portable electronic device 105 receives this information by querying the server 110.

Any of the functionality described above as being executed by a specific component of the patient lab test compliance system 100 may be performed, in whole or are in part, on any other component of the patient lab test compliance system 100. For example, in some embodiments, the server 110 determines the patient reminder date and transmits it to the portable electronic device 105. In other embodiments, the portable electronic device 105 determines the patient reminder date based on a lab test order received from the server 110. In other embodiments, the doctor terminal 115 determines the patient reminder date and transmits it to the server 110 in a lab test input.

This disclosure is not limited in its application to the examples provided, the embodiments discussed, or to the details of construction and the arrangement of components set forth in the foregoing description or drawings. The disclosure is capable of other embodiments and of being practiced or of being carried out in various ways.

1. A method of tracking a lab test, the method comprising:
receiving, via a transceiver included in a portable electronic device, the lab test order, the lab test order including a patient identifier, a lab test identifier associated with a lab test, and an action due date for the lab test;
setting and starting, via an electronic processor included in the portable electronic device, a first timer based at least in part on the action due date such that the first timer expires prior to the action due date;
periodically generating a reminder alarm signal after the first timer expires;
receiving, via a server transceiver included in a server, an action complete signal from a lab database, the action complete signal indicating that the lab test has been administered;
responsive to receiving the action complete signal at the server, transmitting, via the server transceiver, the action complete signal to the portable electronic device;
receiving, via the transceiver, the action complete signal;
stopping, via the electronic processor, the periodic generating of the reminder alarm signal when the portable electronic device receives the action complete signal; and
displaying, on a touch-screen display included in the portable electronic device, the lab test identifier.

2. The method of claim 1, further comprising displaying a lab testing facility location on the touch-screen display.

3. (canceled)

4. (canceled)

5. The method of claim 1, further comprising
setting, via the electronic processor, a second timer based at least in part on the action due date;
starting, via the electronic processor, the second timer when the first timer expires;
stopping, via the electronic processor, the second timer when the action complete signal is received; and
generating, via the portable electronic device, an overdue alarm signal when the second timer expires.

6. The method of claim 1, wherein generating the reminder alarm signal includes displaying a visual signal on the touch-screen display.

7. The method of claim 1, wherein the lab test identifier includes at least one selected from a group consisting of a current procedural technology code and a clinical pathology lab code.

8. The method of claim 7, wherein the lab test identifier further includes patient instructions, and wherein the method further comprises displaying the patient instructions on the touch-screen display.

9. The method of claim 1, wherein the patient identifier includes at least one selected from a group consisting of a patient name, a patient account number, and a patient date of birth.

10. The method of claim 1, further comprising displaying a date in which a lab test associated with the lab test identifier was previously administered.

11. The method of claim 1, further comprising setting the first timer based at least in part on the action due date and a date in which a lab test associated with the lab test identifier was previously administered.

12. The method of claim 1, further comprising
receiving, via the server transceiver, a lab test input from a doctor terminal, the lab test input including the patient identifier, the action due date, and the lab test identifier;
transmitting, via the server transceiver, the lab test input to the lab database;
determining, via a server electronic processor included in the server, a patient reminder date based at least in part on the action due date such that the patient reminder date occurs prior to the action due date; and
transmitting, via the server transceiver, the lab test order to the portable electronic device, the lab test order further including the patient reminder date.

13. (canceled)

14. The method of claim 12, further comprising
determining, via the server electronic processor, medical insurance information based at least in part on the patient identifier; and
determining, via the server electronic processor, the patient reminder date based at least in part on the action due date and the medical insurance information.

15. The system of claim 17, wherein the lab test identifier includes at least one selected from a group consisting of a current procedural technology code and a clinical pathology lab code.

16. The system of claim 17, wherein the patient identifier includes at least one selected from a group consisting of a patient name, a patient account number, and a patient date of birth.

17. A system for tracking a lab test order, the system comprising:
a portable electronic device configured to
receive the lab test order, the lab test order including a patient identifier, a lab test identifier associated with a lab test, and an action due date for the lab test,
set and start a first timer based at least in part on the action due date such that the first timer expires prior to the action due date,
periodically generate a reminder alarm signal after the first timer expires,
receive an action complete signal, the action complete signal indicating that the lab test has been administered,
stop the periodic generating of the reminder alarm signal when the action complete signal is received, and
display the lab test identifier on a touch-screen display of the portable electronic device; and
a server configured to
receive the action complete signal from a lab database, and
responsive to receiving the action complete signal, transmit the action complete signal to the portable electronic device.

18. The system of claim 17, wherein the portable electronic device is further configured to display a lab testing facility location on the touch-screen display.

19. (canceled)

20. (canceled)
